(19) United States
(12) Patent Application Publication
(10) Pub. No.: US 2020/0225049 A1
(43) Pub. Date: Jul. 16, 2020

(54) DYNAMIC VEHICLE ROUTING DETERMINATIONS

(71) Applicant: Ford Global Technologies, LLC, Dearborn, MI (US)

(72) Inventor: Alexander BALVA, Palo Alto, CA (US)

(21) Appl. No.: 16/650,194

(22) PCT Filed: Oct. 25, 2017
(86) PCT No.: PCT/US2017/058346

§ 371 Date: Mar. 24, 2020

Related U.S. Application Data
(63) Continuation of application No. 15/724,851, filed on Oct. 4, 2017.

(51) Int. Cl. G01C 21/34; G06Q 10/04; G06Q 50/30

(52) U.S. Cl. CPC G01C 21/3438; G01C 21/343; G01C 21/3446; G06Q 30/0282; G06Q 10/047; G06Q 50/30; G01C 21/3453

(57) ABSTRACT

A provider, such as a transportation management service, can utilize an objective function to balance various metrics when selecting routing options to serve a set of customer trip requests. The objective function can provide a compromise between rider experience and provider economics, taking into account metrics such as rider convenience, operational efficiency, and ability to deliver on confirmed trips. The analysis can consider not only planned trips, or trips currently being planned, but also trips currently in progress. One or more optimization processes can be applied, which can vary the component values or weightings of the objective function, in order to attempt to improve the quality score generated for each proposed routing solution. A solution can be selected for implementation based at least in part upon the resulting quality scores of the proposed routing solutions.

### BACKGROUND

People are increasingly turning to offerings such as ridesharing to accomplish everyday tasks. Ridesharing can involve riders being allocated vehicles that are dedicated to those riders for a period of time, or being allocated seats on vehicles that will have other passengers riding at the same time. While individually allocated cars can have some benefits, sharing vehicles can reduce cost and provide some certainty as to scheduling. The sharing of vehicles among multiple concurrent riders can have various constraints, however, as riders will want some certainty as to the time of the ride and arrival at the destination, such that flexibility of the routes may be limited. It therefore may be desirable to attempt to balance the economics to the provider of maximizing occupancy and utilization of the vehicles with the convenience and experience offered to the riders.

### BRIEF DESCRIPTION OF THE DRAWINGS

Various embodiments in accordance with the present disclosure will be described with reference to the drawings, in which:

FIG. 1 illustrates an example ride request environment in which various embodiments can be implemented.

FIGS. 2A and 2B illustrate example origination and destination locations, and routes for serving those locations, that can be determined for a service area over a period of time in accordance with various embodiments.

FIG. 3 illustrates example service metrics that can be balanced via an objective function in accordance with various embodiments.

FIG. 4 illustrates an example system that can be utilized to implement aspect of the various embodiments.

FIG. 5 illustrates an example process for determining a routing solution for a set of trip requests that can be utilized in accordance with various embodiments.

FIG. 6 illustrates an example process for optimizing proposed routing solutions that can be utilized in accordance with various embodiments.

FIG. 7 illustrates an example computing device that can be utilized to submit trip requests and receive route options in accordance with various embodiments.

FIG. 8 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the providing of transportation in response to various requests. In particular, various embodiments provide approaches for determining and selecting from various routing solutions to serve a set of transportation requests. The requests can relate to the transportation of people, animals, packages, or other objects or passengers, from an origination location to a destination location. The requests may also include at least one time component. A provider, such as a transportation service, can utilize an objective function to balance various metrics when selecting between proposed routing solutions to serve a set of customer trip requests. An objective function can provide a compromise between, for example, rider experience and provider economics, taking into account metrics such as rider convenience, operational efficiency, and the ability to deliver on confirmed trips. The analysis can consider not only planned trips, or trips currently being planned, but also trips currently in progress. One or more optimization processes can be applied, which can vary the component values or weightings of the objective function in order to attempt to improve the quality score generated for each proposed routing solution. A solution can be selected for implementation based at least in part upon the resulting quality scores of the proposed routing solutions.

Various other such functions can be used as well within the scope of the various embodiments as would be apparent to one of ordinary skill in the art in light of the teachings and suggestions contained herein.

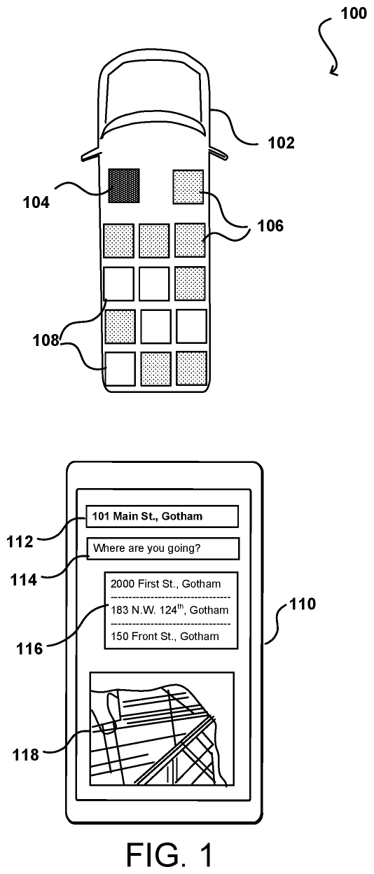

FIG. 1 illustrates an example environment 100 in which aspects of the various embodiments can be implemented. In this example, a user can request transportation from an origination to a destination location using, for example, an application executing on a client computing device 110. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 100 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space for a driver 102 and seats or other capacity for up to a maximum number of riders. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 106 (or other rider locations) may be occupied by riders, while another number of seats 108 may be unoccupied. In some embodiments objects such as packages or deliveries may also occupy available space for a ride as well. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

In the present example, a given user can enter an origination location 112 and a destination location 114, either manually or from a set of suggested locations 116, among other such options, such as by selecting from a map 118 or other interface element. In other embodiments, source such as a machine learning algorithm or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

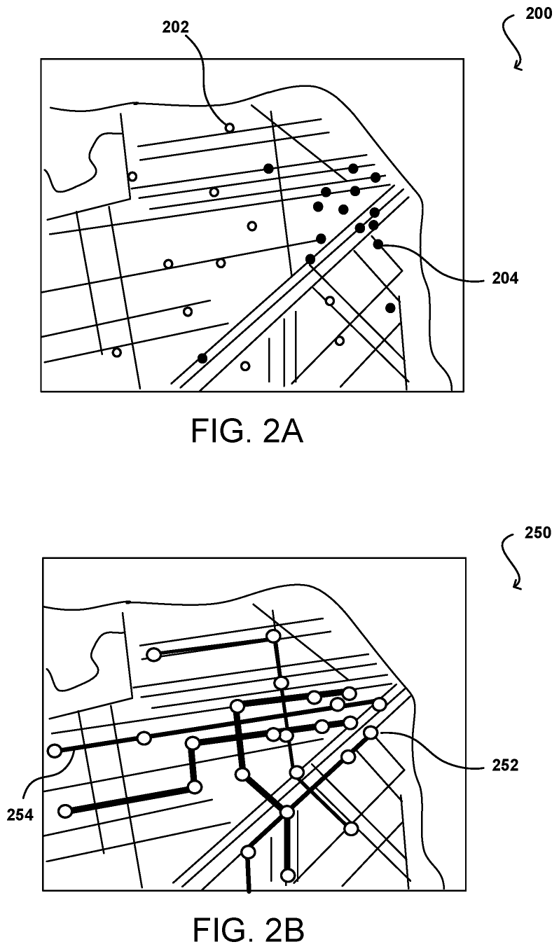

FIGS. 2A and 2B illustrate one example approach that can be utilized to provide such service in accordance with various embodiments. In the example mapping 200 of FIG. 2A, a set of origination points 202 and destination points 204 indicate locations, over a determined period of time, between which one or more users would like to travel. As illustrated, there are clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

It thus can be desirable, in at least some embodiments, to provide routes and transportation options that balance, or at least take into consideration, these and other such factors. As an example, the mapping 250 of FIG. 2B illustrates a selection of routes 252 that can be provided over a period of time in order to satisfy various rider requests. The routes may not include or correspond to each precise origination and destination location, but can come within an acceptable distance of those locations in most instances. There may be situations where origination or destination locations are not served, or served at particular times, where route options may not be available, although in some embodiments a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 252 provided by such a service may change over time, or even at different times of day, but can be sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

Approaches in accordance with various embodiments can utilize at least one objective function to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancellation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board. Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance in some embodiments to represent a portion of the planned distance not yet driven.

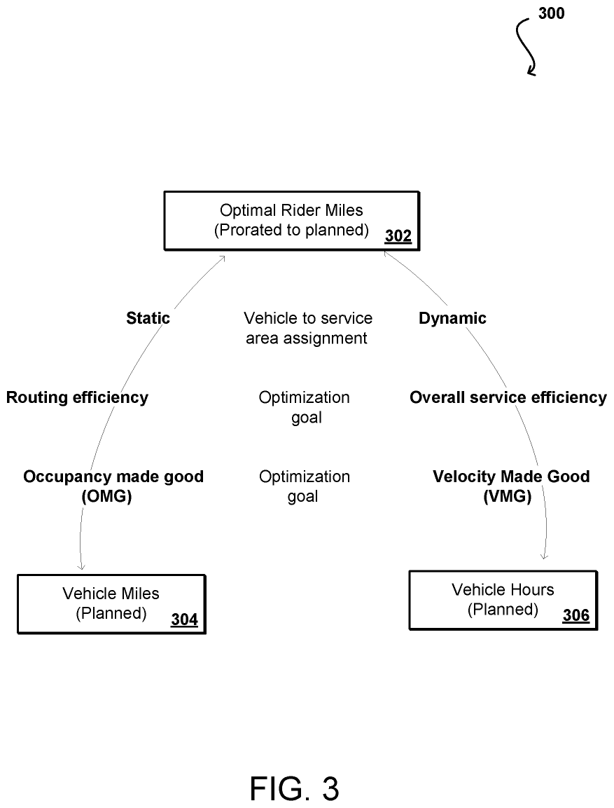

FIG. 3 illustrates an example set of service delivery efficiency metrics 300 that can be utilized in accordance with various embodiments. This example shows an approach that can balance planned vehicle miles with planned vehicle hours, and use these to determine “optimal” rider miles 302 for use in determining service efficiency. The optimal miles can be prorated to planned miles that have not yet been driven. The vehicle miles metric 304 can differ from the vehicle hours metric 306 along a number of different dimensions. For example, the vehicle to service area assignment for vehicle miles can be static, while the assignment for vehicle hours can be dynamic. Further, the optimization goal for a vehicle miles-based approach can be routing efficiency, while the optimization goal for a vehicle hours-based approach can be the overall service efficiency. Another type of optimization metric is referred to herein as a “made good” metric. For vehicle miles, this can be an occupancy made good (OMG) metric, and for vehicle hours this can be a velocity made good (VMG) or similar value. These “made good” metrics can provide an indication of whether specific optimization goals are met, and a balance can be made to make sure that both metrics are balanced while satisfying that goal, in order to provide for adequate occupancy (and thus operational efficiency) with sufficient average velocity (to provide operational efficiency as well as customer service satisfaction). Different objective functions can prioritize either parameter (or a combination of the parameters) based on service goals, but can attempt to ensure that the metrics both satisfy specified service criteria.

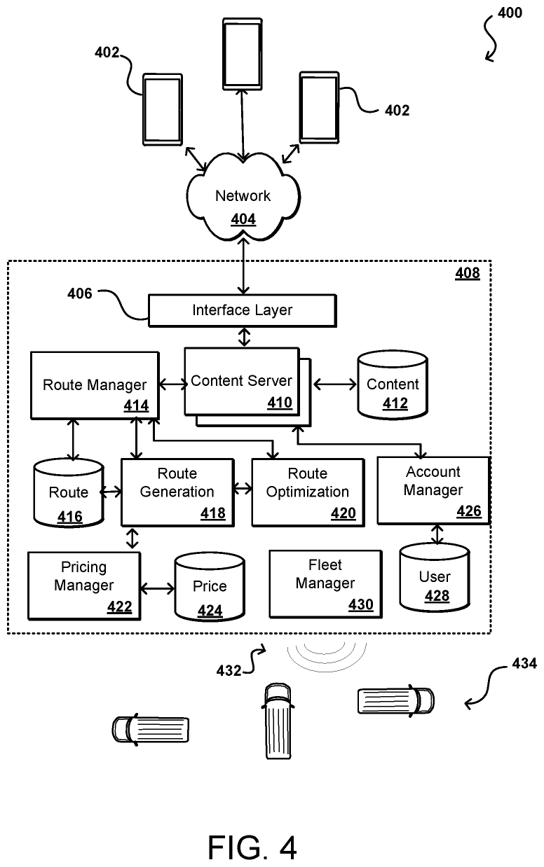

As mentioned, a route optimization system in some embodiments can attempt to utilize such an objective function in order to determine and compare various routing options. FIG. 4 illustrates an example system 400 that can be utilized to determine and manage vehicle routing in accordance with various embodiments. In this system, various users can use applications executing on various types of computing devices 402 to submit route requests over at least one network 404 to be received by an interface layer 406 of a service provider environment 408. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a WiFi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 412 or other such location.

Information for the request can be directed to a route manager 414, such as may include code executing on one or more computing resources, configured to manage aspects of routes to be provided using various vehicles of a vehicle pool or fleet associated with the transport service. The route manager can analyze information for the request, determine available planned routes from a route data store 416 that have capacity can match the criteria of the request, and can provide one or more options back to the corresponding device 402 for selection by the potential rider. The appropriate routes to suggest can be based upon various factors, such as proximity to the origination and destination locations of the request, availability within a determined time window, and the like. In some embodiments, an application on a client device 402 may instead present the available options from which a user can select, and the request can instead involve obtaining a seat for a specific planned route at a particular planned time.

As mentioned, however, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 414 can receive several such requests, and can attempt to determine the best selection of routes to satisfy the various requests. In this example the route manager can work with a route generation module 418 that can take the inputs from the various requests and provide a set of route options that can satisfy those requests. This can include options with different numbers of vehicles, different vehicle selections or placements, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 422 can determine the cost for a specific request using pricing data and guidelines from a price repository 424, which the user can then accept or reject.

In this example, the route generation module 418 can generate a set of routing options based on the received requests for a specified area over a specified period of time. A route optimization module 420 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 420 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

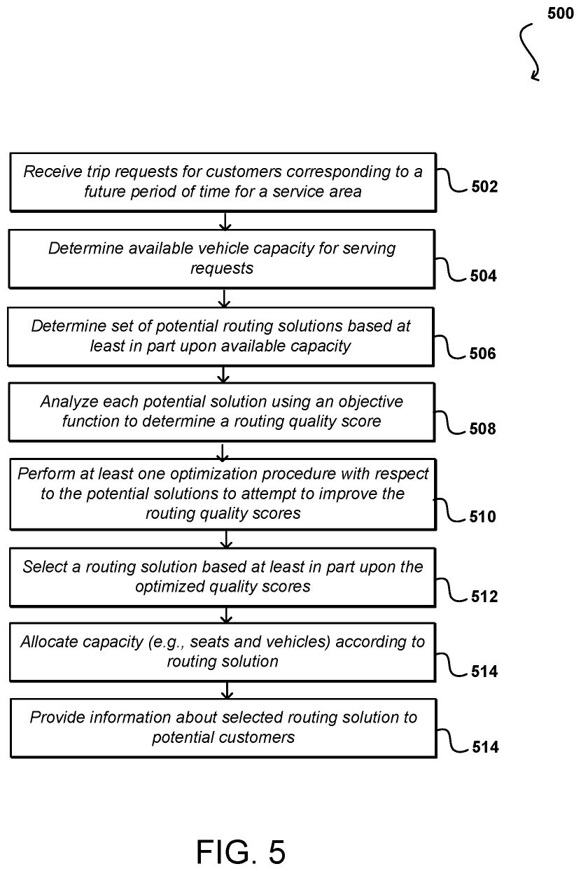

FIG. 5 illustrates an example process 500 for determining routing for a set of user requests that can be utilized in accordance with various embodiments. It should be understood that, for this and other processes discussed herein, there can be additional, fewer, or alternative steps, performed in similar or alternative steps, or in parallel, within the scope of the various embodiments unless otherwise stated. In this example, various trip requests are received 502 from, or on behalf of, various potential customers of a transportation service. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well. In order to determine how to best serve the requests, this example process first determines 504 available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing solutions can be determined 506. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis.

In this example process, the various potential routing solutions can be analyzed 508 using an objective function that balances various factors, such as provider efficiency and customer satisfaction, or at least takes those factors into consideration as discussed elsewhere herein. Each potential routing solution that is analyzed using the function, or at least that meets specific minimum criteria, can be provided with a routing quality score generated inserting the relevant values for the solution into the objective function. This can include, for example determining a weighted combination of various quality factors as discussed herein. In some embodiments, the solution with the best (e.g., highest or lowest) quality score can be selected for implementation. In this example, however, at least one optimization procedure is performed 510 with respect to at least some of the potential solutions. In some embodiments the process might be performed for all potential solutions, while in others only a subset of the solutions will go through an optimization procedure, where solutions with a quality score outside an acceptable range may not be considered for optimization in order to conserve time and resources. The optimization process can attempt to improve the quality scores of the various solutions. As discussed herein, an optimization process can attempt to adjust various parameters of the solution, such as to adjust pickup times, stops per route, capacity distribution, and the like. As mentioned, multiple optimization procedures may be applied in some embodiments, where the algorithms may look at different factors or adjustable ranges, etc. Different optimization algorithms may also optimize for, or prioritize, different factors, such as different QoS or efficiency components, profitability, rider comfort, and the like.

After the optimization, at least some of the various proposed solutions may have updated quality scores. Some of the proposed solutions may also have been removed from consideration based on, for example, unacceptable quality scores or an inability to adequately serve a sufficient number of the pending requests, among other such factors. A specific routing solution can then be selected 512 from the remaining solutions, where the solution can be selected based at least in part upon the optimized quality scores. For example, if optimizing for factors such as profitability or customer satisfaction rating, it can be desirable to select the option with the highest score. If optimizing for factors such as cost, it might be desirable to select the option with the lowest score. Other options can be utilized as well, such as to select the score closest to a target number (e.g., zero). As mentioned, other factors may be considered as well. For example, a solution might be selected that has close to the best quality score, but has a much better profitability or customer satisfaction value, or satisfies one or more other such goals or criteria. Once the solution is determined, the appropriate capacity can be allocated 514 based upon vehicles and seating, among other potential options, determined to be available for the determined region at, or near, the future period of time. This can include, for example, determining routes and stops, and assigning vehicles with appropriate capacity to specific routes. The assignment of specific types of vehicles for certain routes may also be specified in the routing options, as there may be certain types of vehicles that get better gas mileage in town and some that get better gas mileage on the highway, for example, such that operational costs can be broken down by types of vehicles as well. In some embodiments specific vehicles might also be due to service for a specific mileage target, which can be factored in as well as other factors, such as cost per mile, type of gasoline, fuel, or power utilized, and the like. Information about the selected routing option can then be provided 514 to particular customers, such as those associated with the received requests. The information can indicate to the users various aspects such as the time and location of pickup, the route being taken, the location and approximate time of arrival at the destination, and potentially information about the specific vehicle and driver, among other such options.

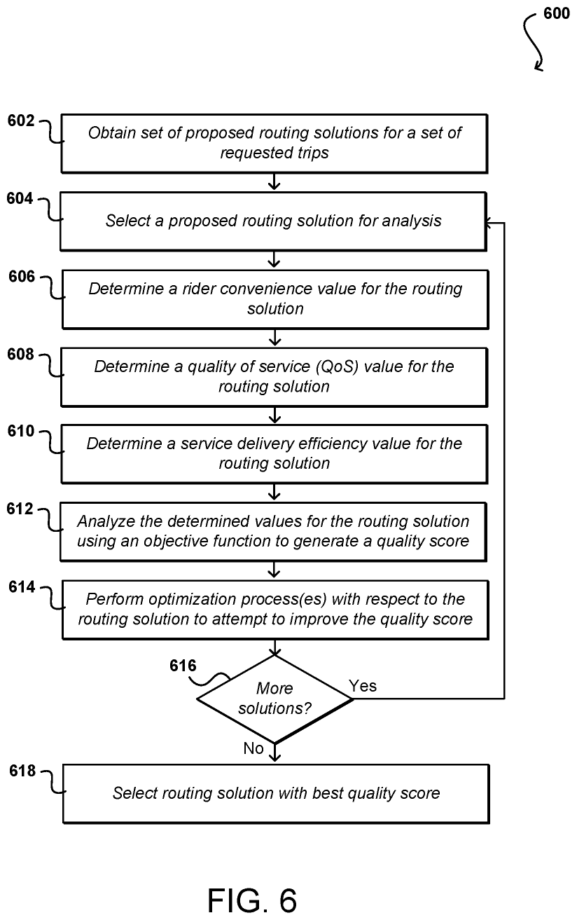

FIG. 6 illustrates an example process 600 that can be used to optimize potential routing solutions in accordance with various embodiments. In this example, a set of proposed routing solutions is obtained 602, such as by using a process discussed with respect to FIG. 5. The potential routing solutions can provide different options for serving a set of ride or trip requests for various customers, among other such options. Once the solutions are obtained, the solutions can be analyzed and/or optimized in an attempt to determine a best available solution for the received and/or anticipated requests. In this example, at least a subset of the routing solutions will be selected 604 for analysis. This may include solutions that satisfy minimum criteria, such as being able to serve at least a minimum percentage of the requests, or satisfy a minimum variation from the requested trips, among other such options. For a given solution to be analyzed, various values can be determined, a selection of which are presented in this flowchart. Although shown in series for simplicity of explanation, it should be understood that the determinations can be done in parallel or other orders as well within the scope of the various embodiments.

In this example, at least one rider convenience values is determined 606 for the potential routing solution. As mentioned, a metric such as rider convenience can be used to ensure that trips offered to riders are competitively convenient, or at least in line with convenience offered by competitive services. The types of competitive services can be determined using any appropriate mechanism, and updated as appropriate. Whether or not an offering is competitively convenient can be based upon a number of factors, such as may relate to variations in distance, time, capacity, delays, and the like. In this example, a rider convenience value is calculated based upon a weighted function of a number of different parameters, where the relative weighting can be based at least in part upon the determined impact of each factor. A primary factor in the rider convenience value can be the inability to provide any trip options. For example, an inability to provide a route option that is within a maximum allowable distance of a requested origination or destination location within a determined time window, as well as an ability to provide an option that does not exceed a maximum delay time or number of stops, etc. Another factor can be whether a pickup and delivery time can be provided within a specified range of times for the request, as well as a factor indicating a difference in time from a requested pick up or delivery to an anticipated pickup or delivery, with the difference in time negatively impacting the convenience determination. As mentioned elsewhere herein, other factors can relate to a walking or travel distance between the requested and provided origination locations, as well as for the destination locations. The distance can also be determined with respect to an actual origin or destination of the customer, regardless of their requested locations. Factors can also relate to the planned capacity or seating utilization, the amount of backtracking along the route, the desirability of the origination or destination location, as well as the deviation from the optimal path, among other such options.

In addition, at least one quality of service (QoS) value can be determined 608 for the routing solution. Such a metric can help to ensure that convenience remains uncompromised, to the extent possible or practical, throughout the delivery of the transportation service. The value can be impacted by various factors, as may relate to the cancellation of all or a portion of a trip, which can have the largest impact on the overall QoS value if a service is unable to be delivered. Other factors can relate to the previously-indicated performance as well, as may relate to a breach in the committed latest arrival time, which can either be based upon the amount of time after the committed arrival or can be a binary in some embodiments based on whether or not the committed time was met. Similar factors can relate to whether the pick-up or drop-off locations were changed or reassigned, whether the passengers had to wait while on the vehicle, whether the vehicle was reassigned, or whether the latest committed pick-up time was missed. In some embodiments, the historical performance of a route can be used to provide the data for this metric, and can also be broken down by vehicle, time of day, driver, type of vehicle, and the like.

Further, at least one service delivery efficiency value can be determined 610 for the proposed routing option. Inclusion of such a metric can help to ensure that fleet operations are efficient as well. As mentioned, in some embodiments this can be determined using at least two different operational models, such as may be based upon static and dynamic vehicle assignment. For static vehicle assignment, vehicles can be committed to a service area for the entire duration of a service period, such that the labor cost is fixed and an attempt can be made to minimize driving distance without regard to the length of time in service. Another model can utilize dynamic vehicle assignment, wherein vehicles can be brought in and out of service as needed, such that the labor cost is variable. Accordingly, an attempt can be made to minimize time in service as well as driving distance. Some approaches use a combination of both methods, whereby there are a number of vehicles with static assignment and other vehicles available for dynamic assignment as needed. Approaches for determining the optimal values to use for various service delivery efficiency calculations are discussed in detail elsewhere herein.

Once the various metric values are determined, the objective function can be applied to analyze 612 the values and generate a quality score for the proposed routing solution. Separate from, or as a part of the calculation, at least one optimization process can be performed 614 with respect to the determined routing option, to attempt to improve the associated quality score. As mentioned, this can involve varying some of the metric values, and their component values, as well as the weightings and other aspects within allowable ranges or variances. If there are more proposed routing solutions to consider, the process can continue. Once the proposed solutions have been evaluated and/or optimized, a routing solution can be selected 618 based at least in part upon that solution having the best quality score. This can include, for example, the highest or lowest score, or another such score as discussed and suggested elsewhere herein. As mentioned, in some embodiments optimization processed might not be performed, or may be performed offline in order to attempt to improve the objective function used for subsequent determinations.

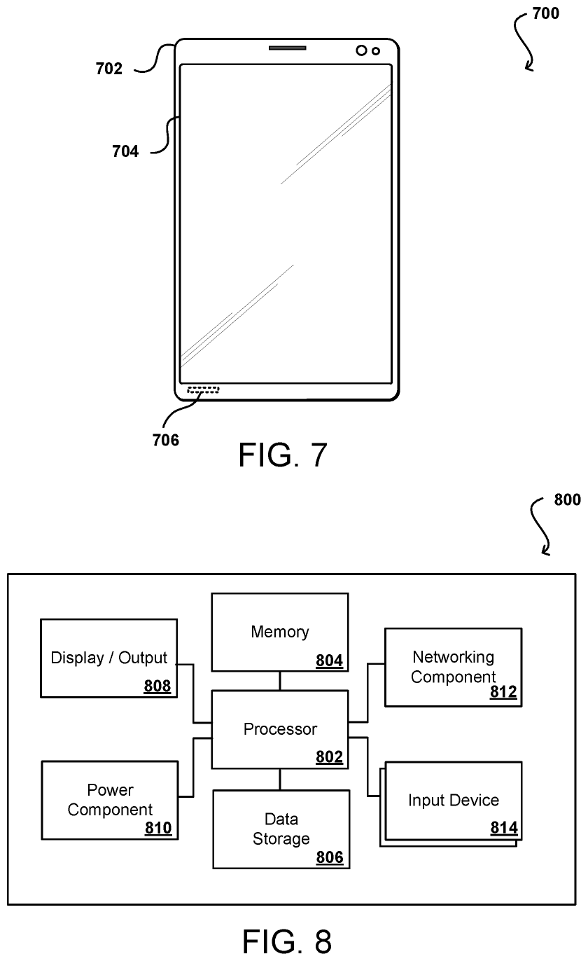

FIG. 7 illustrates an example computing device 700 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 700 has an outer casing 702 covering the various internal components, and a display screen 704 such as a touch screen capable of receiving user input during operation of the device. These can be additional display or output components as well, and not all computing devices will include display screens as known in the art. The device can include one or more networking or communication components 706, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 8 illustrates an example set of components that can comprise a computing device 800 such as the device described with respect to FIG. 7, as well as computing devices for other purposes such as application servers and data servers. The illustrated example device includes at least one main processor 802 for executing instructions stored in physical memory 804 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 806 for the device. Application instructions for execution by the at least one processor 802 can be stored by the data storage 806 then loaded into memory 804 as needed for operation of the device 800. The processor can also have internal memory in some embodiments for temporarily storing data and instructions for processing. The device can also support removable memory useful for sharing information with other devices. The device will also include one or more power components 810 for powering the device. The power components can include, for example, a battery compartment for powering the device using a rechargeable battery, an internal power supply, or a port for receiving external power, among other such options.

The computing device may include, or be in communication with, at least one type of display element 808, such as a touch screen, organic light emitting diode (OLED), or liquid crystal display (LCD). Some devices may include multiple display elements, as may also include LEDs, projectors, and the like. The device can include at least one communication or networking component 812, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 814 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
receiving a set of trip requests, a trip request of the set specifying at least a number of passengers, an origin, a destination, and a time component;
determining a set of potential routing solutions to serve the trips requests;
analyzing the set of potential routing solutions using an objective function to generate respective quality scores for the potential routing solutions, the objective routing function including at least one passenger convenience parameter and at least one operational efficiency parameter;
processing at least a subset of the potential routing solutions using an optimization process to improve at least a subset of the respective quality scores;
determining a selected routing solution, from the set of potential routing solutions, based at least in part upon the respective quality scores; and
transmitting information for the selected routing solutions to one or more vehicles selected to serve at least one trip request per the selected routing solution.

2. The computer-implemented method of claim 1, further comprising:
determining a respective value for the passenger convenience parameter for a potential routing solution based at least in part upon at least one of an inability to provide a requested trip option, a variance from a requested departure or arrival time, an amount of anticipated trip delay, an amount of passenger travel between the origin and destination outside the routing solution, a seating utilization of a respective vehicle, an amount of route deviation, or a desirability of at least one stop along a specified route of the potential routing solution.

3. The computer-implemented method of claim 1, further comprising:
determining a respective value for a quality of service parameter for a potential routing solution according to the objective routing function, the respective value determined based at least in part upon at least one of a likelihood or occurrence of trip cancellation, a breach in committed departure or arrival time, a change in stop location, an amount of in-vehicle waiting time, or a vehicle change for a trip.

4. The computer-implemented method of claim 1, further comprising:
determining a respective value for a service delivery efficiency parameter for a potential routing solution according to the objective routing function, the respective value being determined based at least in part upon at least one of a fixed labor cost for a static vehicle assignment solution or a variable labor cost for a dynamic vehicle assignment solution.

5. The computer-implemented method of claim 4, further comprising:
determining the respective value for the delivery efficiency parameter for a potential routing solution further based on a comparison of optimal rider miles to at least one of planned vehicle miles or planned vehicle hours, the optimal rider miles calculated independent of routing conditions for a specific trip.

6. The computer-implemented method of claim 5, wherein at least one of the planned vehicle miles or planned vehicle hours includes prorated values for trips currently in progress.

7. The computer-implemented method of claim 5, further comprising:
optimizing the optimal rider miles using at least an occupancy made good metric for planned vehicle miles or a velocity made good metric for planned vehicle hours, the occupancy made good metric optimizing for routing efficiency and the velocity made good metric optimizing for service efficiency.

8. A computer-implemented method, comprising:
receiving a route request associated with a plurality of trips between an origin and a destination;
determining respective route quality values for a set of potential routing solutions based at least in part on at least one operational efficiency metric and at least one rider experience metric;
determining a selected routing solution, of the set of potential routing solutions, based at least in part upon the respective route quality values; and
transmitting, to a device associated with a vehicle to provide the plurality of trips, machine-readable information indicative of the selected routing solution.

9. The computer-implemented method of claim 8, further comprising:
computing the respective route quality values using an objective function including a weighted combination of a set of quality metrics, the set of quality metrics including the at least one operational efficiency metric and at least one rider experience metric.

10. The computer-implemented method of claim 9, further comprising:
updating the weightings of the quality metrics for the objective function based on output of a machine learning model trained using historical and recent route performance data.

11. The computer-implemented method of claim 8, further comprising:
processing at least a subset of the potential routing solutions using an optimization algorithm to attempt to improve the respective route quality values.

12. The computer-implemented method of claim 8, further comprising:
receiving a plurality of route requests with respective origin, destination, and time components; and
determining the set of potential routing solutions based at least in part upon an anticipated vehicle capacity to serve the plurality of route requests per the respective time components.

13. The computer-implemented method of claim 12, further comprising
determining available capacity of each of a set of vehicle types, each vehicle type having a corresponding passenger capacity; and
determining the set of potential routing solutions based further in part upon the number of each vehicle type comprising the anticipated vehicle capacity.

14. The computer-implemented method of claim 8, further comprising:
determining a respective value for the rider convenience parameter of the rider experience metric, the respective value being determined based at least in part upon at least one of an inability to provide a requested trip option, a variance from a requested departure or arrival time, an amount of anticipated trip delay, an amount of rider travel between the origin and destination outside the routing solution, a seating utilization of a respective vehicle, an amount of route deviation, or a desirability of at least one stop along a specified route of the potential routing solution.

15. The computer-implemented method of claim 8, further comprising:
determining a respective value for a quality of service parameter of the rider experience metric, the respective value being determined based at least in part upon at least one of a likelihood or occurrence of trip cancellation, a breach in committed departure or arrival time, a change in stop location, an amount of in-vehicle waiting time, or a vehicle change for a trip.

16. The computer-implemented method of claim 8, further comprising:
determining a respective value for a service delivery efficiency parameter of the operational efficiency metric, the respective value being determined based at least in part upon at least one of a fixed labor cost for a static vehicle assignment solution or a variable labor cost for a dynamic vehicle assignment solution; the respective values for the delivery efficiency parameter for a potential routing solution being further based on a comparison of optimal rider miles to at least one of planned vehicle miles or planned vehicle hours, the optimal rider miles calculated independent of routing conditions for a specific trip, wherein at least one of the planned vehicle miles or planned vehicle hours include prorated values for trips currently in progress.

17. The computer-implemented method of claim 8, further comprising:
determining, for an individual trip segment of the plurality of trips for a route request, a respective distance of the individual trip segment;
determining, based at least in part upon the respective distances, a total route distance for each potential routing solution including different combinations of the individual trip segments; and
determining, for the potential routing options, the respective route quality values based further on the respective total route distances.

18. A system, comprising:
at least one processor; and
memory including instructions that, when executed by the at least one processor, cause the system to:
receive a set of trip requests, each trip request specifying at least an origin and a destination;
determine a set of potential routing solutions to serve the trips requests;
analyze the set of potential routing solutions using an objective function to generate respective quality scores for the set of potential routing solutions, the objective routing function including at least one rider convenience parameter and at least one operational efficiency parameter;
determine a selected routing solution, from the set of potential routing solutions, based at least in part upon the respective quality scores; and
provide information for the selected routing solutions to one or more computing devices associated with vehicles selected to serve at least one trip request per the selected routing solution.

19. The system of claim 18, wherein the instructions when executed further cause the system to:
determine a respective value for the rider convenience parameter for a potential routing solution based at least in part upon at least one of an inability to provide a requested trip option, a variance from a requested departure or arrival time, an amount of anticipated trip delay, an amount of rider travel between the origin and destination outside the routing solution, a seating utilization of a respective vehicle, an amount of route deviation, or a desirability of at least one stop along a specified route of the potential routing solution.

20. The system of claim 18, wherein the instructions when executed further cause the system to:
determine a respective value for a service delivery efficiency parameter for a potential routing solution according to the objective routing function, the respective value being determined based at least in part upon at least one of a fixed labor cost for a static vehicle assignment solution or a variable labor cost for a dynamic vehicle assignment solution, the the respective values for the delivery efficiency parameter for a potential routing solution being determined further based on a comparison of optimal rider miles to at least one of planned vehicle miles or planned vehicle hours, the optimal rider miles calculated independent of routing conditions for a specific trip, wherein at least one of the planned vehicle miles or planned vehicle hours includes prorated values for trips currently in progress.
